(19) United States
(12) Patent Application Publication
(10) Pub. No.: US 2026/0192242 A1
(43) Pub. Date: Jul. 9, 2026

(54) SYSTEMS AND METHODS OF RENEWABLE NATURAL GAS PROCESSING

(71) Applicant: Alchemy CO2, PBC, Atlanta, GA (US)

(72) Inventors: Casey J. Leist, Atlanta, GA (US); Noah A. Leinwand, New York, NY (US); Christopher S. Carson, Bussum (NL)

(21) Appl. No.: 19/410,230

(22) Filed: Dec. 5, 2025

Related U.S. Application Data
(63) Continuation of application No. PCT/US2024/033087, filed on Jun. 7, 2024.
(60) Provisional application No. 63/471,624, filed on Jun. 7, 2023.
(60) Provisional application No. 63/471,625, filed on Jun. 7, 2023.
(60) Provisional application No. 63/471,626, filed on Jun. 7, 2023.
(60) Provisional application No. 63/471,628, filed on Jun. 7, 2023.
(60) Provisional application No. 63/545,070, filed on Oct. 20, 2023.
(60) Provisional application No. 63/548,011, filed on Nov. 10, 2023.

(51) Int. Cl. B01D 53/22; B01D 53/04; B01D 53/047; B01D 53/26; C10L 3/08; C10L 3/10

(52) U.S. Cl. CPC B01D 53/229; B01D 53/0446; B01D 53/0462; B01D 53/047; B01D 53/226; B01D 53/26; C10L 3/08; C10L 3/104; C10L 3/106; B01D 2256/22; B01D 2256/245; B01D 2257/504; B01D 2257/80; B01D 2258/05; B01D 2259/40052; B01D 2259/40056; C10L 2290/08; C10L 2290/10; C10L 2290/12; C10L 2290/542; C10L 2290/548

(57) ABSTRACT

Gas recovery systems include a source gas conditioning assembly including a compression component and a swing adsorption component and configured to provide a conditioned source gas, a first membrane assembly configured to separate the conditioned source gas into a hydrocarbon enriched stream and a recovery stream, a second membrane assembly configured to separate the hydrocarbon enriched stream into a hydrocarbon product stream and a recycle stream, a carbon dioxide (CO₂) swing adsorption component configured to provide, from a recovery stream, a CO₂ enriched stream and a flush gas stream, a CO₂ plant assembly configured to provide, from the CO₂ enriched stream, a carbon dioxide product stream and an enriched recycle stream, and a standalone membrane assembly configured to separate the enriched recycle stream into a hydrocarbon enriched recycle stream and an effluent stream.

### CLAIM TO PRIORITY

This application claims priority to and is a continuation of International Patent Application Serial No. PCT/US2024/033087, filed Jun. 7, 2024, published as WO2024/254510 and entitled “SYSTEMS AND METHODS OF RENEWABLE NATURAL GAS PROCESSING” (ACO2-0001-WO3).

International Patent Application Serial No. PCT/US2024/033087 claims priority to and is related to U.S. Application Ser. Nos. 63/471,624 filed Jun. 7, 2023 (2112.0003), 63/471,625 filed Jun. 7, 2023 (2112.0004), 63/471,626 filed Jun. 7, 2023 (2112.0005), 63/471,628 filed Jun. 7, 2023 (2112.0006), 63/545,070 filed Oct. 20, 2023 (2112.0009), and 63/548,011 filed Nov. 10, 2023 (2112.0010).

Each of the foregoing applications are incorporated by reference in their entireties herein for all purposes.

### BACKGROUND

Presently known gas recovery systems suffer from a number of challenges. For example, recovery gas streams, such as landfill gas, have a number of constituents that are not primary natural gas constituents (e.g., methane). Accordingly, those constituents lead to excessive energy utilization to maintain high recycle rates, a significant portion of pumping energy committed to recycling non-valuable gas constituents, loss of hydrocarbon product gas to purge streams, or the like.

### SUMMARY

Example embodiments of the present disclosure provide for systems capable to perform essentially 100% recovery of a primary product (e.g., natural gas or methane) and a secondary product (e.g., CO₂), from a gas source such as landfill gas and/or a biogas. Example embodiments of the present disclosure provide for gas compression costs and recycle rates for a membrane-based gas recovery system. Example embodiments of the present disclosure utilize residual pressure from a CO₂ plant to operate a standalone membrane, and/or drive recycle gas for the gas recovery system. Example embodiments of the present disclosure integrate secondary recovery of a primary product, for example from a standalone membrane, for recycling to a gas source (e.g., a hydrocarbon enriched stream) and/or to a CO₂ plant (e.g., a CO₂ enriched stream). Example embodiments of the present disclosure provide for a zero-emission system.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts an example gas recovery system.

FIG. 2 depicts an example gas recovery system.

FIG. 3 depicts an example gas recovery system.

FIG. 4 depicts an example gas recovery system.

FIG. 5 depicts an example gas recovery system.

FIG. 6 depicts an example gas recovery system.

FIG. 7 depicts an example gas recovery system.

FIG. 8 depicts an example gas recovery system.

FIG. 9 depicts an example gas recovery system.

FIG. 10 depicts an example gas recovery system.

### DETAILED DESCRIPTION

Before the present disclosure is described in further detail, it is to be understood that the disclosure is not limited to the particular embodiments described. It is also understood that the terminology used herein is for the purpose of describing particular embodiments only, and is not intended to be limiting. The scope of the present disclosure will be limited only by the claims. As used herein, the singular forms “a”, “an”, and “the” include plural embodiments unless the context clearly dictates otherwise.

In this application, unless otherwise clear from context, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; and (iv) the terms “about” and “approximately” are used as equivalents and may be understood to permit standard variation as would be understood by those of ordinary skill in the art; and (v) where ranges are provided, endpoints are included.

Composition: as used herein, may be used to refer to a discrete physical entity that comprises one or more specified components. In general, unless otherwise specified, a composition may be of any form—e.g., gas, gel, liquid, solid, etc. In some embodiments, “composition” may refer to a combination of two or more entities for use in a single embodiment or as part of the same article. It is not required in all embodiments that the combination of entities result in physical admixture, that is, combination as separate co-entities of each of the components of the composition is possible; however many practitioners in the field may find it advantageous to prepare a composition that is an admixture of two or more of the ingredients in a pharmaceutically acceptable carrier, diluent, or excipient, making it possible to administer the component ingredients of the combination at the same time.

Improve, increase, or reduce: as used herein or grammatical equivalents thereof, indicate values that are relative to a baseline measurement, such as a measurement in a similar composition made according to previously known methods.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

Embodiments herein provide for systems, procedures, and/or apparatuses for providing recovered process streams for renewable natural gas recovery and/or upgrading. Aspects of the present disclosure reference “natural gas” for clarity of the description. The term “natural gas” should be understood broadly, and includes renewable natural gas, landfill gas, fossil fuel natural gas, gas from biodigesters, and the like. Example recovered process streams include, without limitation, improved natural gas recovery (e.g., volume, composition, and/or recovery cost), secondary natural gas recovery, and/or carbon dioxide product recovery. In certain embodiments, example systems, procedures, and/or apparatuses for renewable natural gas recovery are applicable to any type of natural gas stream, and/or gas stream including typical natural gas constituents (e.g., low carbon count hydrocarbons, such as methane, ethane, propane, butane, etc.) as a major portion thereof, including for example processing of landfill gases, or any other type of gases, such as biogas, coming from certain food waste streams, farm product streams, manure sources, waste treatment plants, wineries, and/or any facility having organic waste associated therewith. Example and non-limiting product streams for embodiments herein include, without limitation, one or more of a primary natural gas stream, a secondary natural gas stream, and/or a carbon dioxide stream. In certain embodiments, a product stream, as utilized herein, may be provided as an explicit product stream (e.g., provided to an external system, such as a natural gas pipeline, etc.), utilized internally (e.g., in a burner, as a constituent supply stream, for in-situ electricity generation, etc.), stored for later delivery and/or utilization, etc. The description herein referencing a product stream should be understood broadly, where a product stream includes any stream that has been processed herein and is ready for utilization or further processing for a purpose. Throughout this disclosure, the terms carbon dioxide and CO₂ are used interchangeably.

The description herein referencing certain streams as a permeate stream and/or a retentate stream are non-limiting examples for clarity of the present description. The number and arrangement of membranes, streams, and the like, is dependent upon the constituents of various streams, the characteristics of the membranes utilized (e.g., selectivity, permeability to various constituents being separated, operating pressures, etc.), system pressures, temperatures, and/or flow rates, or the like. The description herein referencing certain streams as product streams, permeate streams, retentate streams, intermediate streams, recycle streams, recovery streams, or the like, are non-limiting examples provided for clarity of the present description. Arrangements depicted herein, including arrangements described herein and/or consistent with descriptions herein, are non-limiting examples, and can be adjusted as described herein and/or as understood to one of skill in the art having the benefit of the present disclosure, and further such arrangements are not limited to naming conventions utilized herein.

Gas separation and purification processes may be used to maximize the value of carbon dioxide (CO₂) capture and/or recovery at renewable natural gas (RNG) facilities and organic waste processing facilities, such as landfills and biodigesters. Disclosed herein are systems, apparatus, and methods that enable the capture of CO₂ from organic waste. The disclosed systems, apparatus, and methods may also enable the conversion of captured CO₂ into a usable form.

Systems depicted herein are depicted schematically, and depicted components thereof may be omitted and/or an omitted component may be added and/or substituted. For example, components to implement and/or adjust stream order and/or connection points (e.g., valves and/or manifolds) may be added, omitted, and/or substituted to implement described flow arrangements. In another example, pressurization components (e.g., a pump) may be added, for example to ensure desired flow rates and/or operating pressures are maintained, and/or depicted pressurization components may be omitted if they are not needed to support the desired flow rates and/or operating pressures for a particular embodiment.

It can be seen that embodiments herein can be configured for zero emissions, or stated differently, the source gas may be completely separated into a hydrocarbon product stream and a CO₂ product stream, with no significant mass vented from the system as a purge gas, effluent, or the like. In certain embodiments, for example where some components are removed in conditioning steps (e.g., H₂S, water, volatile organic compounds, etc.), a zero emission embodiment is one where the entire remainder of the source gas after the conditioning is separated into a hydrocarbon product stream and a CO₂ product stream, with no significant mass vented from the system. It will be understood that the embodiments herein provide for numerous benefits to gas recovery systems, and systems with zero emissions or with non-zero emissions are contemplated herein.

It can be seen that embodiments herein can be configured for minimum possible emissions, or stated differently the source gas may be completely separated into a hydrocarbon product stream, a CO₂ product stream, and a minimum amount of purge material that allows for the separation to be performed with sufficient gas quality for the hydrocarbon product stream and/or CO₂ product stream. For example, an adsorption component (e.g., a volatile organic compounds (VOC) pressure swing adsorber and/or temperature swing adsorber) may utilize flush gas to regenerate the adsorber, where the flush gas and entrained VOCs may be vented and/or oxidized to minimize flush gas emissions and prevent build-up of the VOCs (or other removed impurities) within the gas recovery system and/or as a significant fraction of either product stream. It will be understood that the embodiments herein provide for numerous benefits to gas recover systems, and system with minimum possible emissions, or with higher levels of emissions, are contemplated herein.

Selection of components, stream arrangements, or the like, for embodiments herein may be selected or implemented based on a number of factors, such as the existing biogas upgrading process being employed, the purity and/or cleanliness of the inlet gas (e.g., presence of trace compounds, contaminants, the product fraction of the inlet gas including natural gas and/or CO₂), the volume of methane and/or carbon dioxide that can potentially be re-captured, the intended utilization (e.g., on-site vs. shipping off-site), a comparison of grid electricity costs vs. using the methane to produce electricity on-site, the need or ability to use the electricity for non-CO₂ related uses, if returned methane (and/or natural gas) is desired as an outcome of the process, to meet one or more emissions requirements or comply with a policy, a capital expenditure associated with methane utilization, available space and/or infrastructure for new and/or upgraded equipment, a potential amount of revenue generated through renewable identification numbers (RINs) or other government incentive, an available transportation equipment, supply and demand for a given market, or the like.

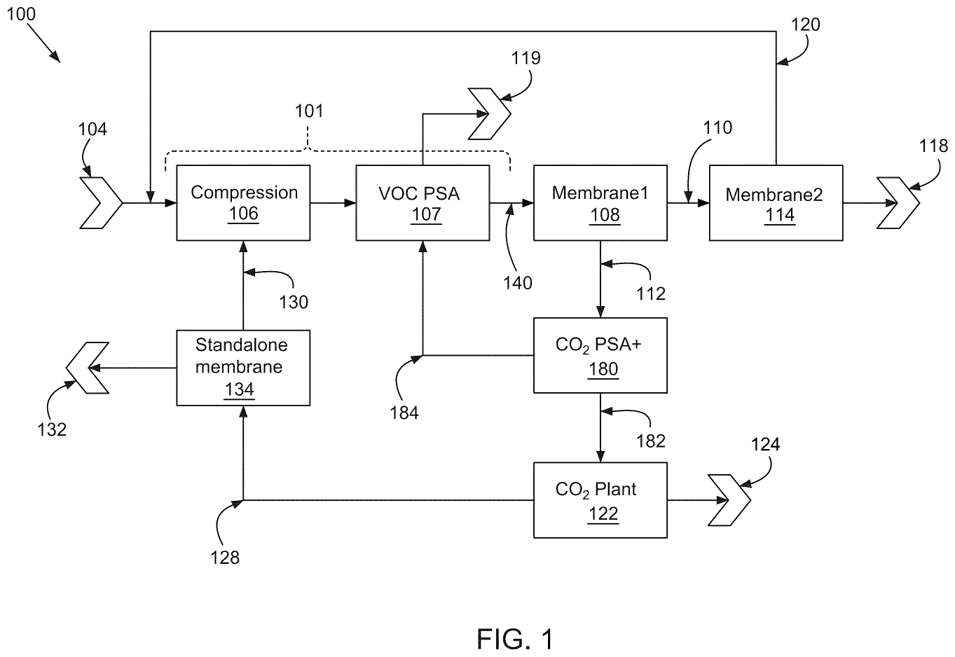

Referring to FIG. 1, an example gas recovery system 100 includes a source gas conditioning assembly 101 fluidly coupled to an inlet source gas 104, the source gas conditioning assembly 101 including a compression component 106 and a swing adsorption component 107, and configured to provide a conditioned source gas 140. The example gas recovery system 100 also includes a first membrane assembly 108 fluidly coupled to the conditioned source gas 140, and configured to separate the conditioned source gas 140 into a hydrocarbon-enriched stream 110 and a recovery stream 112. The example gas recovery system 100 also includes a second membrane assembly 114 fluidly coupled to the hydrocarbon-enriched stream 110, and configured to separate the hydrocarbon-enriched stream 110 into a hydrocarbon product stream 118 and a recycle stream 120. The example gas recovery system 100 also includes a carbon dioxide (CO₂) swing adsorption component 180 fluidly coupled to the recovery stream 112, and configured to provide a CO₂ enriched stream 182 and a flush gas stream 184. The example gas recovery system 100 also includes a CO₂ plant assembly 122 fluidly coupled to the CO₂ enriched stream 182, and configured to provide a carbon dioxide product stream 124 and an enriched recycle stream 128. The example gas recovery system 100 also includes a standalone membrane assembly 134 fluidly coupled to the enriched recycle stream 128, and configured to separate the enriched recycle stream 128 into a hydrocarbon-enriched recycle stream 130 and an effluent stream 132. The swing adsorption component 107 is at least selectively coupled to the flush gas stream 184, and the source gas conditioning assembly 101 is fluidly coupled to the recycle stream 120 and the hydrocarbon-enriched recycle stream 130. The swing adsorption component 107 may have an output 119 in this and other examples in this specification. In the example gas recovery system 100, the hydrocarbon-enriched recycle stream 130 includes a retentate of a standalone membrane of the standalone membrane assembly 134. In the example gas recovery system 100, the source gas conditioning assembly 101 includes a first fluid coupling to the hydrocarbon-enriched recycle stream 130 and a second fluid coupling to the recycle stream 120, and the first fluid coupling is downstream of the second fluid coupling. The first fluid coupling includes a higher average pressure position than the second fluid coupling. The first fluid coupling is downstream of the compressor component 106 of the source gas conditioning assembly 101. The recycle stream 120 includes a permeate of a second membrane of the second membrane assembly 114. The recovery stream 112 includes a permeate of a first membrane of the first membrane assembly 108. The enriched recycle stream 128 comprises non-condensable gases from the CO₂ plant assembly 122. The enriched recycle stream 128 passes directly from the CO₂ plant assembly 122 to the standalone membrane assembly 134 without being pressurized. The CO₂ plant assembly 122 includes a carbon adsorption bed, a gas compression component, a gas dehydration component, and a liquefaction component.

An example apparatus includes a standalone membrane assembly 134 configured to receive a treated waste gas stream, the treated waste gas stream comprising a purge stream of a CO₂ plant 122 operating on CO₂ enriched stream 182 from a CO₂ adsorption component 180, separate the treated waste gas stream into a hydrocarbon-enriched stream 130 and an effluent stream 132, and provide the hydrocarbon-enriched stream 130 to a waste gas recovery facility, wherein the hydrocarbon-enriched stream 130 is recycled to a position upstream of the CO₂ adsorption component 180. In the example apparatus, the hydrocarbon-enriched stream 130 includes a retentate stream of a standalone membrane of the standalone membrane assembly 134.

A method of treating gas includes conditioning a source gas including a compression component and a swing adsorption component to provide a conditioned source gas, separating the conditioned source gas into a hydrocarbon enriched stream and a recovery stream, separating the hydrocarbon enriched stream into a hydrocarbon product stream and a recycle stream, providing a CO₂ enriched stream and a flush gas stream via a carbon dioxide (CO₂) swing adsorption component fluidly coupled to the recovery stream, providing a carbon dioxide product stream and an enriched recycle stream via a CO₂ plant assembly fluidly coupled to the CO₂ enriched stream, and separating the enriched recycle stream into a hydrocarbon enriched recycle stream and an effluent stream.

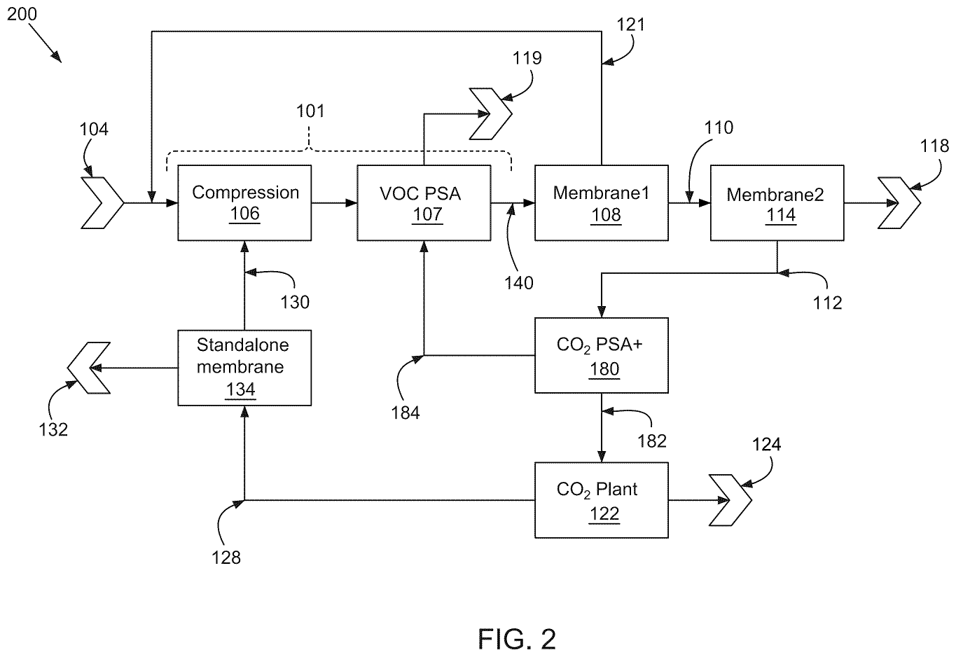

Referring to FIG. 2, an example gas recovery system 200 includes a source gas conditioning assembly 101 fluidly coupled to an inlet source gas 104, the source gas conditioning assembly 101 including a compression component 106 and a swing adsorption component 107, and configured to provide a conditioned source gas 140. The example gas recovery system 200 also includes a first membrane assembly 108 fluidly coupled to the conditioned source gas 140, and configured to separate the conditioned source gas 140 into a hydrocarbon-enriched stream 110 and a recycle stream 121. The example gas recovery system 200 also includes a second membrane assembly 114 fluidly coupled to the hydrocarbon-enriched stream 110, and configured to separate the hydrocarbon-enriched stream 110 into a hydrocarbon product stream 118 and a recovery stream 112. The example gas recovery system 200 also includes a carbon dioxide (CO₂) swing adsorption component 180 fluidly coupled to the recovery stream 112, and configured to provide a CO₂ enriched stream 182 and a flush gas stream 184. The example gas recovery system 200 also includes a CO₂ plant assembly 122 fluidly coupled to the CO₂ enriched stream 182, and configured to provide a carbon dioxide product stream 124 and an enriched recycle stream 128. The example gas recovery system 200 also includes a standalone membrane assembly 134 fluidly coupled to the enriched recycle stream 128, and configured to separate the enriched recycle stream 128 into a hydrocarbon-enriched recycle stream 130 and an effluent stream 132. The swing adsorption component 107 is at least selectively coupled to the flush gas stream 184, and the source gas conditioning assembly 101 is fluidly coupled to the recycle stream 121 and the hydrocarbon-enriched recycle stream 130. In the example gas recovery system 200, the hydrocarbon-enriched recycle stream 130 includes a retentate of a standalone membrane of the standalone membrane assembly 134. The source gas conditioning assembly 101 includes a first fluid coupling to the hydrocarbon-enriched recycle stream 130 and a second fluid coupling to the recycle stream 121, and wherein the first fluid coupling is downstream of the second fluid coupling. The first fluid coupling includes a higher average pressure position than the second fluid coupling. The first fluid coupling is downstream of the compressor component 106 of the source gas conditioning assembly 101. In the example gas recovery system 200, the recycle stream 121 includes a permeate of a first membrane of the first membrane assembly 108. In the example gas recovery system 200, the recovery stream 112 includes a permeate of a second membrane of the second membrane assembly 114. In the example gas recovery system 200, the enriched recycle stream 128 includes non-condensable gases from the CO₂ plant assembly 122. The enriched recycle stream 128 passes directly from the CO₂ plant assembly 122 to the standalone membrane assembly 134 without being pressurized. In the example gas recovery system 200, the CO₂ plant assembly 122 includes a carbon adsorption bed, a gas compression component, a gas dehydration component, and a liquefaction component.

A method of treating gas includes conditioning an inlet source gas, the source gas to provide a conditioned source gas, separating the conditioned source gas into a hydrocarbon enriched stream and a recycle stream, separating the hydrocarbon enriched stream into a hydrocarbon product stream and a recovery stream, providing a CO₂ enriched stream and a flush gas stream via a carbon dioxide (CO₂) swing adsorption component fluidly coupled to the recovery stream, providing a carbon dioxide product stream and an enriched recycle stream via a CO₂ plant assembly fluidly coupled to the CO₂ enriched stream, and separating the enriched recycle stream into a hydrocarbon enriched recycle stream and an effluent stream.

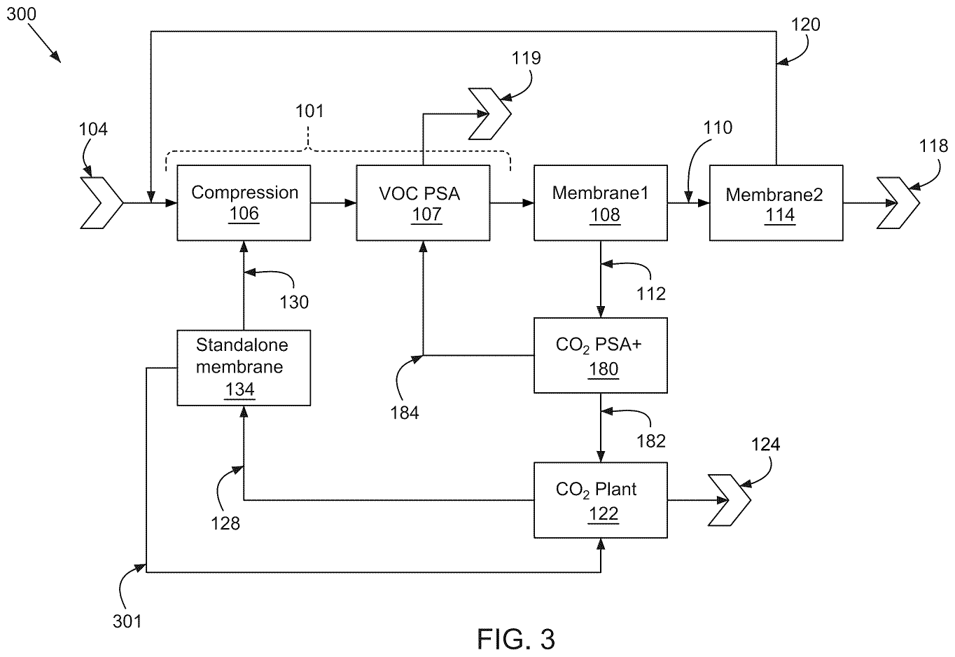

Referring now to FIG. 3, an example gas recovery system 300 includes a source gas conditioning assembly 101 fluidly coupled to an inlet source gas 104, the source gas conditioning assembly 101 including a compression component 106 and a swing adsorption component 107, and configured to provide a conditioned source gas 140. The example gas recovery system 300 also includes a first membrane assembly 108 fluidly coupled to the conditioned source gas 140, and configured to separate the conditioned source gas 140 into a hydrocarbon-enriched stream 110 and a recovery stream 112. The example gas recovery system 300 also includes a second membrane assembly 114 fluidly coupled to the hydrocarbon-enriched stream 110, and configured to separate the hydrocarbon-enriched stream 110 into a hydrocarbon product stream 118 and a recycle stream 120. The example gas recovery system 300 also includes a carbon dioxide (CO₂) swing adsorption component 180 fluidly coupled to the recovery stream 112, and configured to provide a CO₂ enriched stream 182 and a flush gas stream 184. The example gas recovery system 300 also includes a CO₂ plant assembly 122 fluidly coupled to the CO₂ enriched stream 182, and configured to provide a carbon dioxide product stream 124 and an enriched recycle stream 128. The example gas recovery system 300 also includes a standalone membrane assembly 134 fluidly coupled to the enriched recycle stream 128, and configured to separate the enriched recycle stream 128 into a hydrocarbon-enriched recycle stream 130 and a secondary recovery stream 301. The CO₂ plant assembly 122 is fluidly coupled to the secondary recovery stream 301. The swing adsorption component 107 is at least selectively coupled to the flush gas stream 184, and the source gas conditioning assembly 101 is fluidly coupled to the recycle stream 120 and the hydrocarbon-enriched recycle stream 130. In the example gas recovery system 300, the hydrocarbon-enriched recycle stream 130 comprises a retentate of a standalone membrane of the standalone membrane assembly 134. In the example gas recovery system 300, the source gas conditioning assembly 101 includes a first fluid coupling to the hydrocarbon-enriched recycle stream 130 and a second fluid coupling to the recycle stream 120, and wherein the first fluid coupling is downstream of the second fluid coupling. The first fluid coupling includes a higher average pressure position than the second fluid coupling. The first fluid coupling is downstream of the compressor component 106 of the source gas conditioning assembly 101.

An example apparatus includes a standalone membrane assembly 134 configured to receive a treated waste gas stream, the treated waste gas stream including a purge stream of a CO₂ plant 122 operating on a CO₂ enriched stream 182 from a CO₂ adsorption component 180, separate the treated waste gas stream into a hydrocarbon-enriched stream 130 and a secondary recovery stream 301, provide the hydrocarbon-enriched stream 130 to a waste gas recovery facility, wherein the hydrocarbon-enriched stream 130 is recycled to a position upstream of the CO₂ adsorption component 180, and provide the secondary recovery stream 301 to the CO₂ plant 122. In the example apparatus, the hydrocarbon-enriched stream 110 includes a retentate stream of a standalone membrane of the standalone membrane assembly 134.

A method of treating gas includes conditioning an inlet source gas via a compression component and a swing adsorption component to provide a conditioned source gas, separating the conditioned source gas into a hydrocarbon enriched stream and a recovery stream, separating the hydrocarbon enriched stream into a hydrocarbon product stream and a recycle stream, providing a CO₂ enriched stream and a flush gas stream via a carbon dioxide (CO₂) swing adsorption component fluidly coupled to the recovery stream, providing a carbon dioxide product stream and an enriched recycle stream via a CO₂ plant assembly fluidly coupled to the CO₂ enriched stream, and separating the enriched recycle stream into a hydrocarbon enriched recycle stream and a secondary recovery stream.

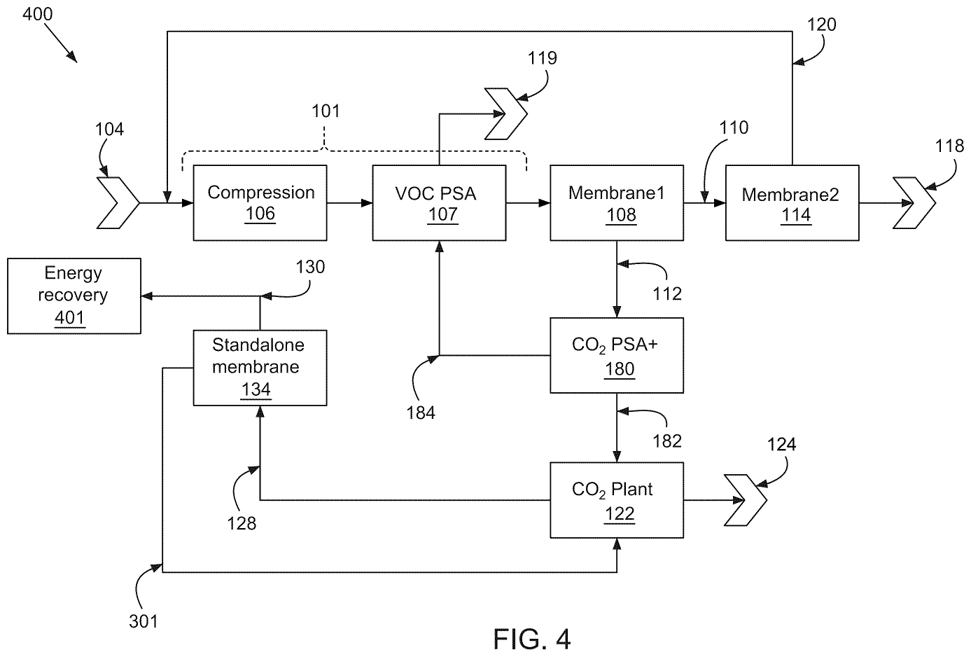

Referring to FIG. 4, an example gas recovery system 400 includes a source gas conditioning assembly 101 fluidly coupled to an inlet source gas 104, the source gas conditioning assembly 101 including a compression component 106 and a swing adsorption component 107, and configured to provide a conditioned source gas 140. The example gas recovery system 400 also includes a first membrane assembly 108 fluidly coupled to the conditioned source gas 140, and configured to separate the conditioned source gas 140 into a hydrocarbon-enriched stream 110 and a recovery stream 112. The example gas recovery system 400 also includes a second membrane assembly 114 fluidly coupled to the hydrocarbon-enriched stream 110, and configured to separate the hydrocarbon-enriched stream 110 into a hydrocarbon product stream 118 and a recycle stream 120. The example gas recovery system 400 also includes a carbon dioxide (CO₂) swing adsorption component 180 fluidly coupled to the recovery stream 112, and configured to provide a CO₂ enriched stream 182 and a flush gas stream 184. The example gas recovery system 400 also includes a CO₂ plant assembly 122 fluidly coupled to the CO₂ enriched stream 182, and configured to provide a carbon dioxide product stream 124 and an enriched recycle stream 128. The example gas recovery system 400 also includes a standalone membrane assembly 134 fluidly coupled to the enriched recycle stream 128, and configured to separate the enriched recycle stream 128 into a hydrocarbon-enriched recycle stream 130 and a secondary recovery stream 301. The example gas recovery system 400 also includes an energy recovery assembly 401 fluidly coupled to the hydrocarbon-enriched recycle stream 130. In the example gas recovery system 400, the CO₂ plant assembly 122 is fluidly coupled to the secondary recovery stream 301. In the example gas recovery system 400, the swing adsorption component 107 is at least selectively coupled to the flush gas stream 184. In the example gas recovery system 400, the source gas conditioning assembly 101 is fluidly coupled to the recycle stream 120. In the example gas recovery system 400, the energy recovery assembly 401 includes a burner, a fuel cell, or a generator.

An example apparatus includes a standalone membrane assembly 134 configured to receive a treated waste gas stream, the treated waste gas stream including a purge stream of a CO₂ plant 122 operating on a CO₂ enriched stream 182 from a CO₂ adsorption component 180, separate the treated waste gas stream into a hydrocarbon-enriched stream 130 and a secondary recovery stream 301, provide the hydrocarbon-enriched stream 130 to an energy recovery assembly 401, and provide the secondary recovery stream 301 to the CO₂ plant 122.

A method of treating gas includes conditioning to an inlet source gas via a compression component and a swing adsorption component to provide a conditioned source gas, separating the conditioned source gas into a hydrocarbon enriched stream and a recovery stream, separating the hydrocarbon enriched stream into a hydrocarbon product stream and a recycle stream, providing a CO₂ enriched stream and a flush gas stream via a carbon dioxide (CO₂) swing adsorption component fluidly coupled to the recovery stream, providing a carbon dioxide product stream and an enriched recycle stream via a CO₂ plant assembly fluidly coupled to the CO₂ enriched stream, and separating the enriched recycle stream into a hydrocarbon enriched recycle stream and a secondary recovery stream.

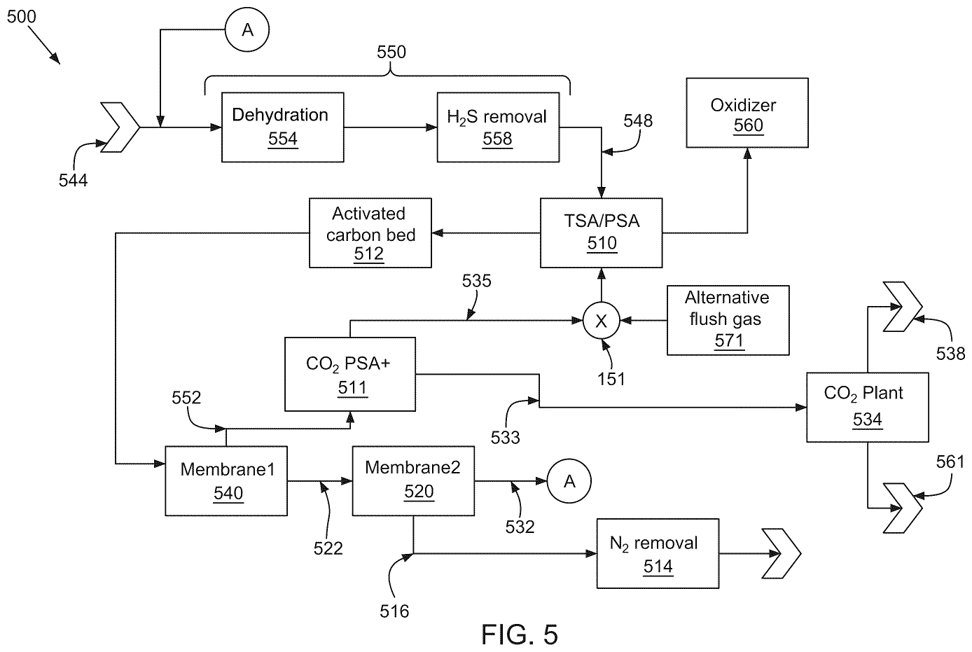

Referring now to FIG. 5, an example gas recovery system 500 includes a source gas conditioning assembly 550 fluidly coupled to an inlet source gas 544, the source gas conditioning assembly 550 comprising a compression component and a swing adsorption component 510, and configured to provide a conditioned source gas 548. The example gas recovery system 500 also includes a first membrane assembly 540 fluidly coupled to the conditioned source gas 548, and configured to separate the conditioned source gas 548 into a hydrocarbon-enriched stream 522 and a recovery stream 552. The example gas recovery system 500 also includes a second membrane assembly 520 fluidly coupled to the hydrocarbon-enriched stream 522, and configured to separate the hydrocarbon-enriched stream 522 into a hydrocarbon product stream 516 and a recycle stream 532. The hydrocarbon product stream 516 may be further treated by a nitrogen removal component 514. The example gas recovery system 500 also includes a carbon dioxide (CO₂) adsorption component 511 fluidly coupled to the recovery stream 552, and configured to provide a CO₂ enriched stream 533 and a flush gas stream 535. The example gas recovery system 500 also includes a carbon dioxide (CO₂) plant assembly 534 fluidly at least selectively coupled to CO₂ enriched stream 533, and configured to provide a carbon dioxide product stream 538 and a non-condensable stream 561. In the example gas recovery system 500, the source gas conditioning assembly 550 is fluidly coupled to the recycle stream 532. In the example gas recovery system 500, the swing adsorption component 510 is at least selectively coupled to the flush gas stream 535. In the example gas recovery system 500, the source gas conditioning assembly 550 is fluidly coupled to the non-condensable stream 561.

An example gas recovery system 500 further includes a standalone membrane assembly (not shown) fluidly coupled to the non-condensable stream 561, and configured to separate the non-condensable stream 561 into a second recovery stream and an effluent stream. An example source gas conditioning assembly 550 is fluidly coupled to the second recovery stream. An example CO₂ plant assembly 534 is fluidly coupled to the effluent stream. The example gas recovery system 500 further includes an energy recovery assembly fluidly coupled to the second recovery stream. In an example gas recovery system 500, the CO₂ adsorption component 511 is fluidly coupled to the effluent stream (e.g., as a flush gas). The example gas recovery system 500 further includes an alternative flush gas source 571, and wherein the swing adsorption component 510 is at least selectively coupled to the alternative flush gas source 571. In the example gas recovery system 500, the source gas conditioning assembly 550 further includes an H₂S removal component 558, a dehydration component 554, and an activated carbon bed component 512. The gas recovery system 100 may include a valve 151. In embodiments throughout this disclosure, valves may be disposed in the system to facilitate flexible routing where any or all inputs to the valve can go to any or all outputs, including selectively. Outputs from the swing adsorption component 510 can flow to the oxidizer 560 or activated carbon bed 512.

A method of treating gas includes conditioning an inlet source gas via a compression component and a swing adsorption component to provide a conditioned source gas, separating the conditioned source gas into a hydrocarbon enriched stream and a recovery stream, separating the hydrocarbon enriched stream into a hydrocarbon product stream and a recycle stream, providing a CO₂ enriched stream and a flush gas stream via a carbon dioxide (CO₂) adsorption component fluidly coupled to the recovery stream, and providing a carbon dioxide product stream and a non-condensable stream via a carbon dioxide (CO₂) plant assembly fluidly at least selectively coupled to the recovery stream.

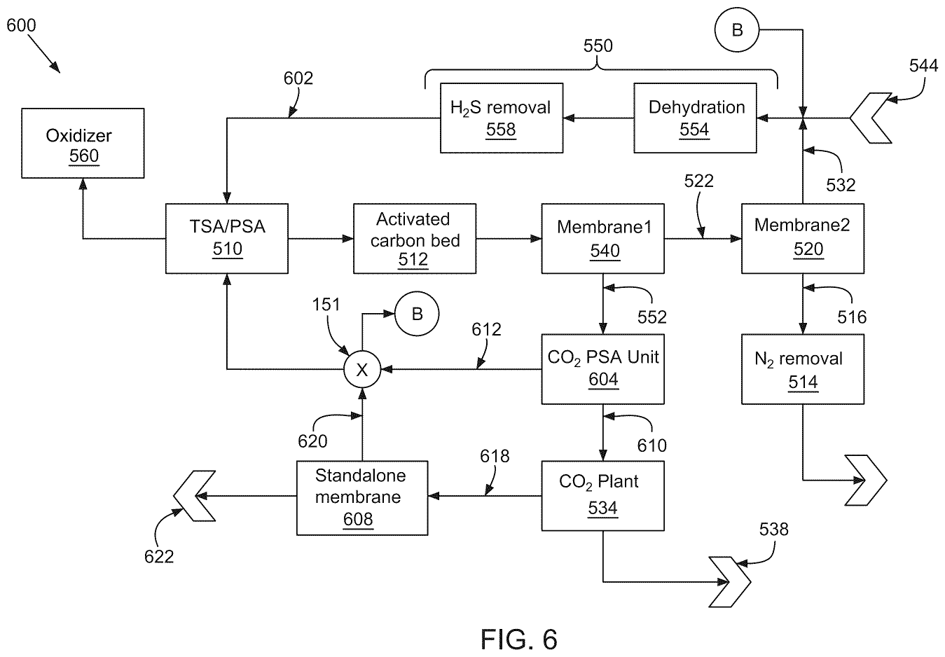

Referring now to FIG. 6, an example gas recovery system 600 includes a source gas conditioning assembly 550 fluidly coupled to an inlet source gas 544, the source gas conditioning assembly comprising a dehydration component 554 and a swing adsorption component 510, and configured to condition and compress the inlet source gas 544 to provide a conditioned source gas 602. The example gas recovery system 600 also includes a first membrane assembly 540 fluidly coupled to the conditioned source gas 602, and configured to separate the conditioned source gas 602 into a hydrocarbon enriched stream 522 and a recovery stream 552. The example gas recovery system 600 also includes a second membrane assembly 520 fluidly coupled to the hydrocarbon enriched stream 522, and configured to separate the hydrocarbon enriched stream 522 into a hydrocarbon product stream 516 and a recycle stream 532. The hydrocarbon product stream 516 may be further processed by a nitrogen removal component 514. The example gas recovery system 600 also includes a carbon dioxide (CO₂) swing adsorption component 604 at least selectively fluidly coupled to the recovery stream 552, and configured to separate the recovery stream 552 into a CO₂ enriched stream 610 and a utility stream 612. The example gas recovery system 600 also includes a CO₂ plant assembly 534 fluidly coupled to the CO₂ enriched stream 610, and configured to provide a carbon dioxide product stream 538 and a second enriched recovery stream 618. The example gas recovery system 600 also includes a standalone membrane assembly 608 fluidly coupled to the second enriched recovery stream 618, and configured to separate the second enriched recovery stream 618 into a hydrocarbon enriched recycle stream 620 and an effluent stream 622. The source gas conditioning assembly 550 is fluidly coupled to the recycle stream 532 and at least selectively coupled to at least one of the hydrocarbon enriched recycle stream 620 or the utility stream 612, and the swing adsorption component 510 is at least selectively coupled to at least one of the effluent stream 622 or the utility stream 612. The example gas recovery system 600 further includes an energy recovery assembly fluidly coupled to the hydrocarbon enriched recycle stream 620. An example swing adsorption component 510 is at least selectively coupled to the recovery stream. The example CO₂ plant assembly 122 is fluidly coupled to the effluent stream 622.

A method of treating gas includes conditioning and compressing an inlet source gas to provide a conditioned source gas, separating the conditioned source gas into a hydrocarbon enriched stream and a recovery stream, separating the hydrocarbon enriched stream into a hydrocarbon product stream and a recycle stream, separating the recovery stream into a CO₂ enriched stream and a utility stream via a carbon dioxide (CO₂) swing adsorption component fluidly coupled to the recovery stream, providing a carbon dioxide product stream and a second enriched recovery stream via a CO₂ plant assembly fluidly coupled to the CO₂ enriched stream, and separating the second enriched recycle stream into a hydrocarbon enriched recycle stream and an effluent stream.

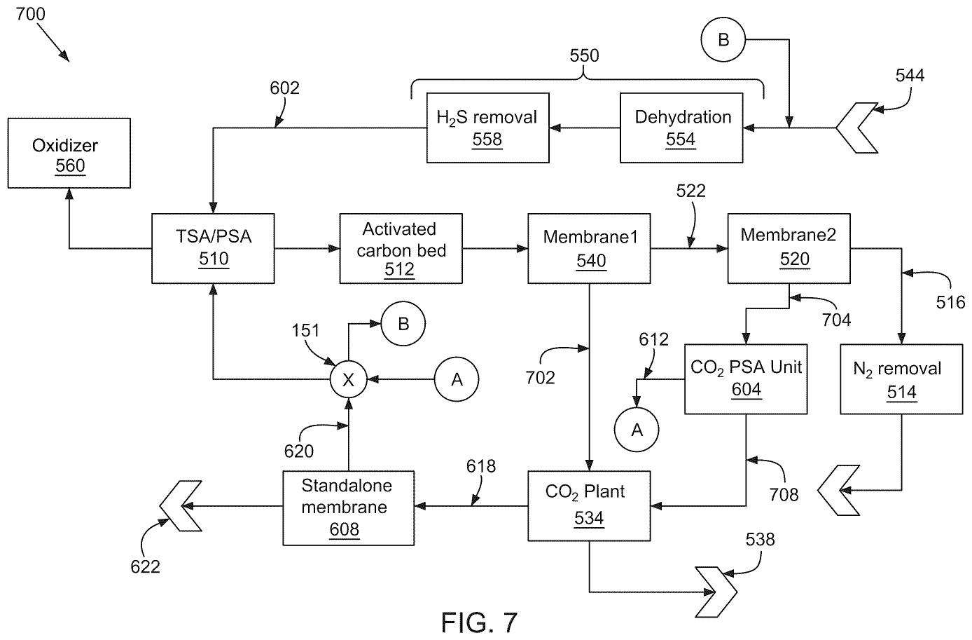

Referring now to FIG. 7, an example gas recovery system 700 includes a source gas conditioning assembly 550 fluidly coupled to an inlet source gas 544, the source gas conditioning assembly comprising a dehydration component 554 and a swing adsorption component 510, and configured to condition and compress the inlet source gas 544 to provide a conditioned source gas 602. The example gas recovery system 700 also includes a first membrane assembly 540 fluidly coupled to the conditioned source gas 602, and configured to separate the conditioned source gas 602 into a hydrocarbon enriched stream 522 and a first recovery stream 702, and a second membrane assembly 520 fluidly coupled to the hydrocarbon enriched stream 522, and configured to separate the hydrocarbon enriched stream 522 into a hydrocarbon product stream 516 and a second recovery stream 704. The hydrocarbon product stream 516 may be further processed by a nitrogen removal component 514. The example gas recovery system 700 also includes a carbon dioxide (CO₂) swing adsorption component 604 fluidly coupled to the second recovery stream 704, and configured to separate the second recovery stream 704 into a CO₂ enriched stream 708 and a utility stream 612. The example gas recovery system 700 also includes a CO₂ plant assembly 534 fluidly coupled to the CO₂ enriched stream 708, and configured to provide a carbon dioxide product stream 538 and a second enriched recovery stream 618. The example gas recovery system 700 also includes a standalone membrane assembly 608 fluidly coupled to the second enriched recovery stream 618, and configured to separate the second enriched recovery stream 618 into a hydrocarbon enriched recycle stream 620 and an effluent stream 622. The source gas conditioning assembly 550 is fluidly coupled to the hydrocarbon enriched recycle stream 620 and at least selectively coupled to at least one of the hydrocarbon enriched recycle stream 620 or the utility stream 612. In examples, the swing adsorption component 604 is at least selectively coupled to at least one of the effluent stream 622 or the utility stream 612. The example gas recovery system 700 further includes an energy recovery assembly fluidly coupled to the hydrocarbon enriched recycle stream 620. In the example gas recovery system 700, the swing adsorption component 510 is at least selectively coupled to the first or second recovery stream. In the example gas recovery system 700, the CO₂ plant assembly is fluidly coupled to the effluent stream 622.

A method of treating gas includes conditioning and compressing an inlet source gas to provide a conditioned source gas, separating the conditioned source gas into a hydrocarbon enriched stream and a first recovery stream, separating the hydrocarbon enriched stream into a hydrocarbon product stream and a second recovery stream, separating the second recovery stream into a CO₂ enriched stream and a utility stream, providing a carbon dioxide product stream and a second enriched recovery stream via a CO₂ plant assembly fluidly coupled to the CO₂ enriched stream, and separating the second enriched recycle stream into a hydrocarbon enriched recycle stream and an effluent stream.

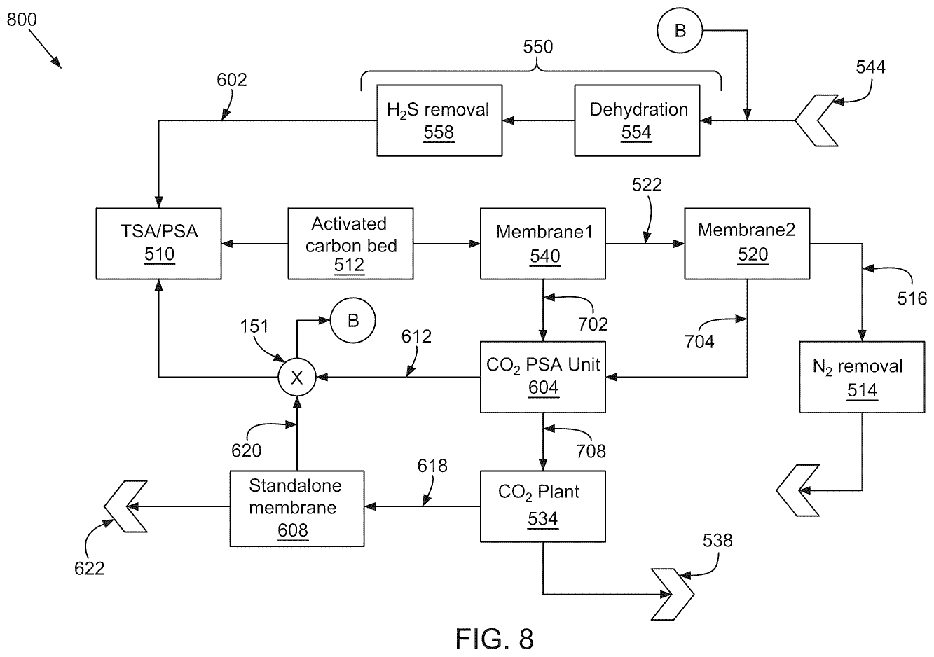

Referring now to FIG. 8, an example gas recovery system 800 includes a source gas conditioning assembly 550 fluidly coupled to an inlet source gas 544, and configured to condition and compress the inlet source gas 544 to provide a conditioned source gas 602. The example gas recovery system 800 also includes a first membrane assembly 540 fluidly coupled to the conditioned source gas 602, and configured to separate the conditioned source gas 602 into a hydrocarbon enriched stream 522 and a first recovery stream 702. The example gas recovery system 800 also includes a second membrane assembly 520 fluidly coupled to the hydrocarbon enriched stream 522, and configured to separate the hydrocarbon enriched stream 522 into a hydrocarbon product stream 516 and a second recovery stream 704. The example gas recovery system 800 also includes a carbon dioxide (CO₂) swing adsorption component 604 fluidly coupled to the first recovery stream 702 and the second recovery stream 704, and configured to provide a CO₂ enriched stream 708 and a utility stream 612. The example gas recovery system 800 also includes a CO₂ plant assembly 534 fluidly coupled to the CO₂ enriched stream 708, and configured to provide a carbon dioxide product stream 538 and an enriched recovery stream 618. The example gas recovery system 800 also includes a standalone membrane assembly 608 fluidly coupled to the enriched recovery stream 618, and configured to separate the enriched recovery stream 618 into a hydrocarbon enriched recycle stream 620 and an effluent stream 622. In the example gas recovery system 800, the source gas conditioning assembly 550 is at least selectively coupled to at least one of the hydrocarbon enriched recycle stream 620 or the utility stream 612. In the example gas recovery system 800, the swing adsorption component 510 is at least selectively coupled to at least one of the effluent stream 622 or the first recovery stream 702. The example gas recovery system 800 further includes an energy recovery assembly fluidly coupled to the hydrocarbon enriched recycle stream 620. The example gas recovery system 700 further includes an energy recovery assembly fluidly coupled to the utility stream 612. In an example embodiment, the CO₂ plant assembly is fluidly coupled to the effluent stream 622 (e.g., to recycle and capture remaining CO₂ in the effluent stream 622).

A method of treating gas includes conditioning and compressing an inlet source gas to provide a conditioned source gas, separating the conditioned source gas into a hydrocarbon enriched stream and a first recovery stream, separating the hydrocarbon enriched stream into a hydrocarbon product stream and a second recovery stream, providing a CO₂ enriched stream and a utility stream via a carbon dioxide (CO₂) swing adsorption component fluidly coupled to first recovery stream and the second recovery stream, providing a carbon dioxide product stream and an enriched recovery stream via a CO₂ plant assembly fluidly coupled to the CO₂ enriched stream, and separating the second enriched recycle stream into a hydrocarbon enriched recycle stream and an effluent stream.

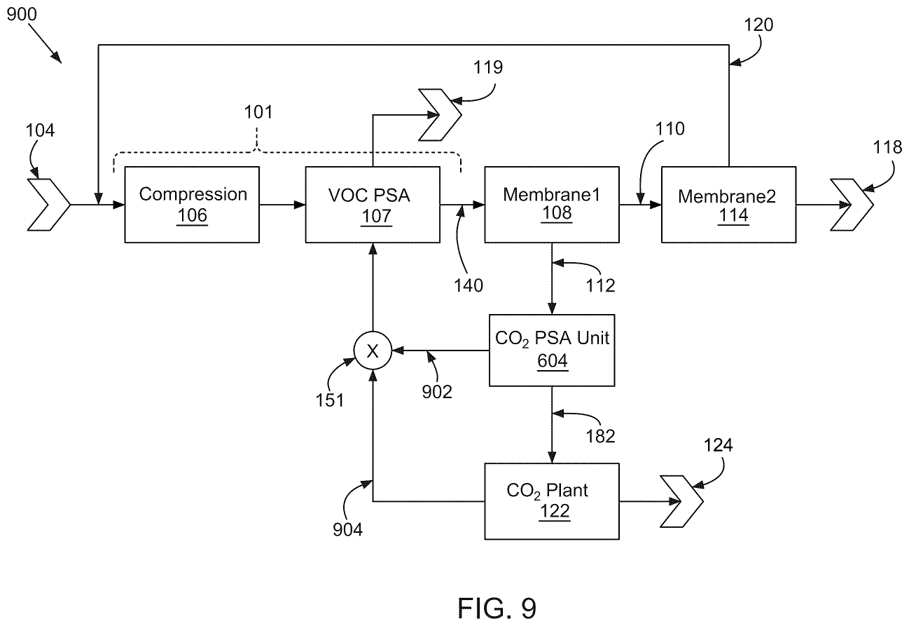

Referring now to FIG. 9, an example gas recovery system 900 includes a source gas conditioning assembly 101 fluidly coupled to an inlet source gas 104, the source gas conditioning assembly 101 including a compression component 106 and a swing adsorption component 107, and configured to provide a conditioned source gas 140. The example gas recovery system 900 also includes a first membrane assembly 108 fluidly coupled to the conditioned source gas 140, and configured to separate the conditioned source gas 140 into a hydrocarbon enriched stream 110 and a recovery stream 112. The example gas recovery system 900 also includes a second membrane assembly 114 fluidly coupled to the hydrocarbon enriched stream 110, and configured to separate the hydrocarbon enriched stream 110 into a hydrocarbon product stream 118 and a recycle stream 120. The example gas recovery system 900 also includes a carbon dioxide (CO₂) swing adsorption component 604 fluidly coupled to the recovery stream 112, and configured to provide a CO₂ enriched stream 182 and a utility stream 902. The example gas recovery system 900 also includes a CO₂ plant assembly 122 fluidly coupled to the CO₂ enriched stream 182, and configured to provide a carbon dioxide product stream 124 and a non-condensable stream 904. In the example gas recovery system 900, the source gas conditioning assembly 101 is fluidly coupled to the recycle stream 120, and the swing adsorption component 107 is at least selectively coupled to the utility stream 902. In an example gas recovery system 900, the swing adsorption component 107 is at least selectively coupled to the non-condensable stream 904.

With continued reference to FIG. 9, while the depicted example gas recovery system includes a recovery stream 112 from the first membrane assembly 108, and a recycle stream 120 from the second membrane assembly 114, it should be understood that streams from either the first membrane assembly 108 or the second membrane assembly 114 can be a recycle stream 120 or a recovery stream 112. For example, another example gas recovery system 900 may include a source gas conditioning assembly 101 fluidly coupled to an inlet source gas 104, the source gas conditioning assembly 101 comprising a compression component 106 and a swing adsorption component 107, and configured to provide a conditioned source gas 140. The example gas recovery system 900 may also include a first membrane assembly 108 fluidly coupled to the conditioned source gas 140, and configured to separate the conditioned source gas 140 into a hydrocarbon enriched stream 110 and a recycle stream 120, and a second membrane assembly 114 fluidly coupled to the hydrocarbon enriched stream 110, and configured to separate the hydrocarbon enriched stream 110 into a hydrocarbon product stream 118 and a recovery stream 112. The example gas recovery system 900 may also include a carbon dioxide (CO₂) swing adsorption component fluidly coupled to the recovery stream, and configured to provide a CO₂ enriched stream and a utility stream, and a CO₂ plant assembly fluidly coupled to the CO₂ enriched stream, and configured to provide a carbon dioxide product stream and a non-condensable stream. In the example gas recovery system 900, the source gas conditioning assembly is fluidly coupled to the recycle stream. In the example gas recovery system 900, the swing adsorption component 107 is at least selectively coupled to the utility stream 902. In the example gas recovery system 900, the swing adsorption component 107 is at least selectively coupled to the non-condensable stream 904.

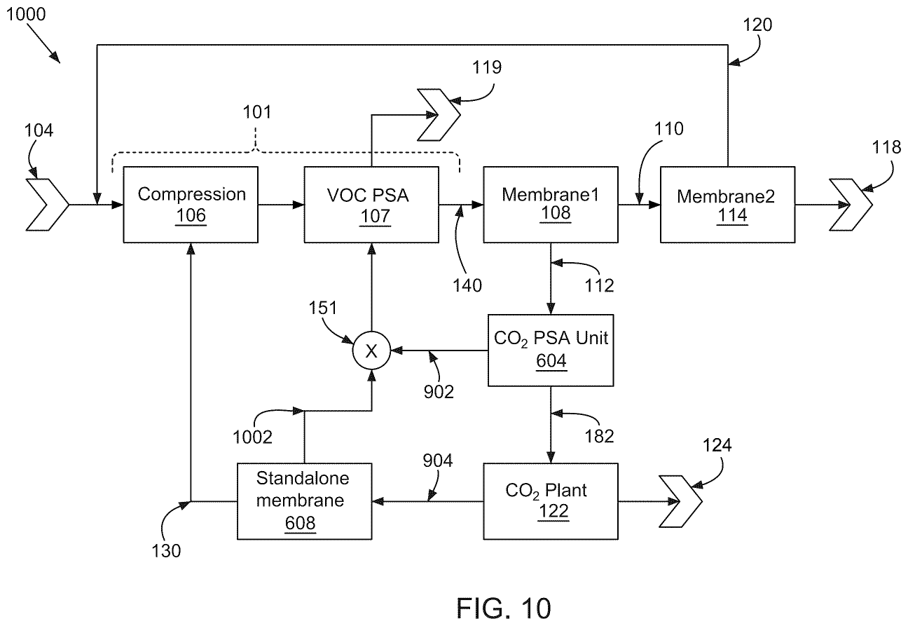

Referring now to FIG. 10, an example gas recovery system 1000 includes a source gas conditioning assembly 101 fluidly coupled to an inlet source gas 104, the source gas conditioning assembly 101 including a compression component 106 and a swing adsorption component 107, and configured to provide a conditioned source gas 140. The example gas recovery system 1000 also includes a first membrane assembly 108 fluidly coupled to the conditioned source gas 140, and configured to separate the conditioned source gas 140 into a hydrocarbon enriched stream 110 and a recovery stream 112. The example gas recovery system 1000 also includes a second membrane assembly 114 fluidly coupled to the hydrocarbon enriched stream 110, and configured to separate the hydrocarbon enriched stream 110 into a hydrocarbon product stream 118 and a recycle stream 120. The example gas recovery system 1000 also includes a carbon dioxide (CO₂) swing adsorption component 604 fluidly coupled to the recovery stream 112, and configured to provide a CO₂ enriched stream 182 and a utility stream 902. The example gas recovery system 1000 also includes a CO₂ plant assembly 122 fluidly coupled to the CO₂ enriched stream 182, and configured to provide a carbon dioxide product stream 124 and a non-condensable stream 904. The example gas recovery system 1000 also includes a standalone membrane assembly 608 fluidly coupled to the non-condensable stream 904, and configured to separate the non-condensable stream 904 into a flush gas stream 1002 and a hydrocarbon enriched recycle stream 130. In the example gas recovery system 1000, the source gas conditioning assembly 101 is fluidly coupled to the recycle stream 120 and the hydrocarbon enriched recycle stream 130, and the swing adsorption component 107 is at least selectively fluidly coupled to the flush gas stream 1002. In the example gas recovery system 1000, the swing adsorption component 107 is at least selectively coupled to the recovery stream 112.

With continued reference to FIG. 10, while the depicted example gas recovery system includes a recovery stream 112 from the first membrane assembly 108, and a recycle stream 120 from the second membrane assembly 114, it should be understood that streams from either the first membrane assembly 108 or the second membrane assembly 114 can be a recycle stream 120 or a recovery stream 112. For example, another example gas recovery system 1000 may include a source gas conditioning assembly 101 fluidly coupled to an inlet source gas 104, the source gas conditioning assembly 101 including a compression component 106 and a swing adsorption component 107, and configured to provide a conditioned source gas 140. The example gas recovery system 1000 also includes a first membrane assembly fluidly coupled to the conditioned source gas 140, and configured to separate the conditioned source gas 140 into a hydrocarbon enriched stream 110 and a recycle stream 120. The example gas recovery system 1000 also includes a second membrane assembly 224 fluidly coupled to the hydrocarbon enriched stream 110, and configured to separate the hydrocarbon enriched stream 110 into a hydrocarbon product stream 118 and a recovery stream 112. The example gas recovery system 1000 also includes a carbon dioxide (CO₂) swing adsorption component 604 fluidly coupled to the recovery stream 112, and configured to provide a CO₂ enriched stream 182 and a utility stream 902. The example gas recovery system 1000 also includes a CO₂ plant assembly 122 fluidly coupled to the CO₂ enriched stream 182, and configured to provide a carbon dioxide product stream 124 and a non-condensable stream 904. The example gas recovery system 1000 also includes a standalone membrane assembly 608 fluidly coupled to the non-condensable stream 904, and configured to separate the non-condensable stream 904 into a flush gas stream 1002 and a hydrocarbon enriched recycle stream 130. In the example gas recovery system 1000, the source gas conditioning assembly 101 is fluidly coupled to the recycle stream 120, and the swing adsorption component 107 is at least selectively coupled to at least one of the flush gas stream 1002 or the utility stream 902. In the example gas recovery system 1000, the swing adsorption component 107 is at least selectively coupled to the non-condensable stream 904. In the example gas recovery system 1000, the source gas conditioning assembly 101 is fluidly coupled to the hydrocarbon enriched recycle stream 130. The example gas recovery system 1000 further includes an energy recovery assembly that is fluidly coupled to the hydrocarbon enriched recycle stream 130.

An example 2-stage renewable natural gas (RNG) upgrading process is described following, which may be embodied in whole or part by embodiments throughout the present disclosure. The depicted process utilizes a two-stage membrane system, such as is used in biodigesters such as dairy waste digesters, food waste digesters, poultry processing plants, wastewater treatment plants, or the like. A biogas inlet stream from a digester is received, for example as a source gas. The process includes a purification and gas conditioning component, for example removing certain gas constituents (e.g., H₂S, sulfur, volatile organic compounds, etc.), dehydration, pressurization, or the like. The biogas is compressed after which it moves through two stages of membranes. The selected pressures and temperature of the outlet biogas may be configured according to the membrane components utilized, which will be understood to the person of skill in the art having the benefit of the present disclosure and information ordinarily available when contemplating a particular system, for example such information including: the composition of the biogas, the desired separation efficiency and/or degree of separation, membrane characteristics, subsequent treatment for the retentate, and/or subsequent treatment for the permeate. The membranes may be hollow fiber membranes or any other suitable, at least partially permeable technology, and may exhibit durability, such as having a lifespan on the order of years (e.g., 3 to 10 years) and selectivity for desired molecules/compounds and/or molecule/compound sizes. Material that passes through the membrane, due to its size or other characteristic, may be known as permeate, while material that does not pass through the membrane, and is therefore retained within the system, may be known as retentate. Any particular arrangements set forth herein are non-limiting examples—for example the permeate and/or retentate in any embodiments may be reversed, the annular stream may be a central stream, and/or membrane arrangements may include cylindrical membranes or any other physical arrangement of the membrane (e.g., planar membranes, rectangular membranes, etc.). The particular arrangement of membranes, physical form of the membranes, utilization of streams as permeate and/or retentate streams, and the like can readily be configured by one of skill in the art according to the available physical components, composition of streams, characteristics of membrane(s), or the like. The permeate may collect at an annulus of the membrane, depending upon the physical configuration of the membrane system, and may be removed from the annulus. Gas flow through the membrane may be in the direction of the hollow fibers. In practice, the membrane may be situated within a system, such as in a pipe, where headers for gas distribution and collection may be on either side of the membrane. The example system is a two-stage membrane system, but may include three membranes, with recycle locations (e.g., gases recycled to be combined with the source gas) selected from any of the three membranes, and/or recovery locations (e.g., gases provided to a CO₂ plant assembly for CO₂ recovery) from any one or two of the three membranes. In certain embodiments, a single membrane system provides a hydrocarbon product stream directly, and a separate recovery stream that is provided to a CO₂ plant assembly, which may be ultimately recycled (e.g., as a non-condensable stream from the CO₂ plant assembly, to a standalone membrane, with the hydrocarbon enriched portion of the standalone membrane separation being recycled).

The example system includes a highly purified methane (CH₄) slip stream return via a standalone membrane unit. The depicted process includes returning excess methane slip that has been removed as part of the CO₂ plant liquefaction process to the RNG producer at high purity to ensure maximum value creation and emission reduction at the site. The return of the methane at high purity improves the process efficiency of the biogas upgrading equipment. The methane slip is purified with a standalone membrane unit as part of the CO₂ recovery process enabling both the recycling of methane with the recovery of CO₂ for potentially revenue-generating end uses. This enables the RNG producer to achieve essentially 100% methane capture and use. The effluent stream (e.g., the permeate, where the retentate is recycled) may be vented, have an energy capture operation (e.g., oxidizing any remaining hydrocarbons and/or operating a fuel cell) performed on it, and/or recycled to the CO₂ plant assembly to further extract any remaining CO₂. The permeate may have a high fraction of CO₂, such as 90% or greater.

An example CO₂ plant assembly includes one or more of: polishing of raw CO₂ with carbon beds (e.g., to remove VOC's and sulfur), other gas conditioning processes, CO₂ compression (e.g., to 300 psi), liquid removal (e.g., drying to-56 degrees dew point), cooling (e.g., using a refrigerant, cooling to ~−25 degrees centigrade), liquefaction (e.g., in a stripper column), or non-condensable gas (e.g., methane, oxygen, nitrogen) removal from the stripper column. The CO₂ plant assembly may produce purified liquid CO₂ from a re-boiler, such as a purity of greater than 99.9%. In some embodiments, the purified CO₂ is directed to storage tanks, and/or otherwise passed into a CO₂ utilization and/or storage system. In addition to providing higher recovery of methane and capture of CO₂ that would otherwise be vented, and at high purity, example systems herein further reduce the operating cost of the RNG plant (e.g., to support higher recycle rates), and increase the capacity of the RNG plant (e.g., allowing a greater portion of the steady state flow through the system to be realized as product stream, e.g., due to the lower recycle rates).

The non-condensable gases from the CO₂ plant assembly, also known as purge gas, which may be a mixture of CO₂ and CH₄, such as a +/−25% CH₄, 75% CO₂ mixture, may be removed from a stripper column of the CO₂ plant assembly at high pressure (e.g., 18 bar, 300 psi). The purge gas may be recycled to the source gas, but the purge gas pressure may need to be let down. In certain embodiments, the purge gas is directed to a standalone membrane, where the elevated pressure effectively operates the standalone membrane, potentially with no additional pressurization. The utilization of the standalone membrane results in greater recovery of CH₄ using less input energy to the process since waste purge stream pressure, also known as waste compression energy, from the CO₂ plant assembly is recovered and used to drive the stand-alone membrane unit to separate CO₂ and methane. Recovery of this waste purge stream pressure enables a more economical recovery of purified, commercially usable, methane. By leveraging the waste pressure of the purge stream, no additional energy needs to be added to the methane slip stream to process the stream through the standalone membrane unit. The pressure available in the waste stream, which is typically wasted, is utilized to further purify the overall waste stream into high purity streams: a high pressure CH₄ stream (e.g., the retentate), and a low pressure CO₂ stream (e.g., the permeate). This high pressure, high purity CH₄ stream can be used for many commercial purposes, such as injection into pipeline, use as an on-site fuel, use in a fuel cell, re-injected into the RNG upgrading process (e.g., at the front end, before compression, after compression, between the first and second stage membranes, etc.), use in a combined heat and power (CHP) system, or the like. In one example, the retentate from the stand-alone membrane unit is returned to the RNG inlet to be combined with the source gas.

Non-condensable gases purged from the CO₂ plant assembly that are not processed through the stand-alone membrane unit may not be suitable to be returned to the process with the conditioned source gas, but may be returned upstream of conditioning components before recycling, and/or may be vented. The retentate may have a variable composition, such as 98% CH₄/2% CO₂, 90% CH₄/10% CO₂, 85% CH₄/15% CO₂, or the like. In embodiments, the composition may be selectable based on a number of factors, such as the size of the membrane, the pressure of the purge gas stream, the temperature of the purge gas stream, the quality of the biogas inlet stream, or the like. In some embodiments, there may be a waste stream of CO₂ or non-condensables from the stand-alone membrane unit.

Another example 2-stage renewable natural gas (RNG) upgrading process is described following. The example process includes passing the low pressure CO₂ stream from a standalone membrane back to the CO₂ plant assembly as a recycle, improving the overall CO₂ recovery of the system. The low pressure CO₂ stream from the standalone membrane may have a significant CO₂ fraction (e.g., 90% or greater), and can significantly increase CO₂ recovery with the recycle to the CO₂ plant assembly. In the example system, both methane and carbon dioxide may be recovered at high rates, such as nearly or equal to 100%, during the RNG upgrading process. In some embodiments, the pressure of the membrane may be varied to achieve specific outcomes for CH₄ and CO₂ recovery. For example, the pressure on the stand-alone membrane may be optimized to achieve a particular level of methane and/or carbon dioxide suitable for a particular intended use or application, and/or to balance stream flow rates, recycle rates, or the like to achieve the desired recovery fraction.

In certain embodiments, the utilization of an additional recycle of the membrane permeate to the CO₂ plant assembly enhances the overall CO₂ recovery of the system. The amount of additional CO₂ recovery depends upon several variables in the system, including the purity of the CO₂ feedgas (the membrane permeate to the CO₂ plant assembly). An example system having a 97% CO₂ purity will result in about 10% additional CO₂ recovery. Another example system having an 88% CO₂ purity will result in about 42% additional CO₂ recovery. The actual amount of additional CO₂ recovery for a given system will depend on a number of factors, for example the temperatures of streams in the system, the pressure drop across various separation membranes, and/or the properties of various separation membranes. The utilization of the additional recycle of the membrane permeate to the CO₂ plant assembly may enhance operations of the CO₂ plant assembly, for example by increasing the average CO₂ purity of streams being processed by the CO₂ plant assembly. The utilization of the additional recycle of the membrane permeate to the CO₂ plant assembly allows for manipulation of energy usage and/or sub-assembly capability of various parts of the overall system, the membrane units, thereby allowing the system to be adapted to the composition of feedgas and the priorities for the system (e.g., operational costs, capital costs, energy costs, maintenance costs, etc.).

Another example 2-stage renewable natural gas (RNG) upgrading process is described following. The example process involves a two-stage membrane system such as is used in biodigesters such as dairy waste digesters, food waste digesters, poultry processing plants, wastewater treatment plants, or the like. The example process includes a highly purified methane (CH₄) slip stream via a standalone membrane unit, which is passed to an energy recovery device. The energy recovery device may be a fuel cell (e.g., operating on methane), a burner, an oxidizer, a generator (e.g., driven by the thermal, chemical, and/or mechanical residual energy in the slip stream), and/or any other energy recovery device. The permeate from the standalone membrane may be recaptured and directed back to the CO₂ plant, and/or may be vented. In certain embodiments, the permeate from the standalone membrane may be utilized as a flush gas, for example where a temperature and/or pressure swing adsorber component is included as a conditioning component for the source gas.

Another example RNG upgrading process is described following. Instead of the 1^{st} stage membrane permeate being used to flush the PSA/TSA, which would re-contaminate the CO₂ stream with impurities, the permeate is sent to a CO₂ liquefaction plant to recover and capture CO₂ and, in its place, an alternate flush gas (e.g., nitrogen, ambient air, argon, helium, other inert gas) is used on the TSA/PSA.

Another example RNG upgrading process is described following. An example system of the process includes a CO₂ PSA/TSA/VPSA adsorption component that processes a recovery stream from one of the membranes, for example a permeate of the first membrane and/or a permeate of the second membrane. The example CO₂ PSA/TSA/VPSA adsorption component generates a CO₂ enriched stream that is relatively pure CO₂ (97% purity or higher), and which is then fed to a CO₂ plant. A tail gas stream from CO₂ PSA/TSA/VPSA adsorption component is an enriched hydrocarbon stream (e.g., +/−15 to 25%) that can be used for other purposes, and/or recycled into the source gas for the RNG upgrading process. PSA/TSA/VPSA references Pressure Swing Adsorption technology (PSA), Temperature Swing Adsorption technology (TSA), Vacuum Pressure Swing Adsorption technology (VPSA), or a combination of these technologies used together.

By increasing the purity of the CO₂ inlet stream to the CO₂ plant, removal of CO₂ from the stripper column, can be increased from, for instance, 60% to 95% of the available CO₂, thereby reducing the capital expenses required for CO₂ capture and processing, and significantly decreasing the required specific energy (kWh per ton of finished product).

In certain embodiments, the permeate from the first membrane is passed to the CO₂ PSA/TSA/VPSA adsorption component, which generates a CO₂ enriched stream that is passed to the CO₂ plant, and the permeate from the second membrane is recycled to the source gas. In certain embodiments, the permeate from the first membrane is passed to the CO₂ plant, and the permeate from the second membrane is passed to a CO₂ PSA/TSA/VPSA adsorption component, which generates a CO₂ enriched stream that is passed to the CO₂ plant. In certain embodiments the permeate from both membranes is passed to the CO₂ PSA/TSA/VPSA adsorption component, which generates a CO₂ enriched stream that is passed to the CO₂ plant. Any one or more of the foregoing examples includes a standalone membrane, for example operating on a non-condensable stream from the CO₂ plant, that provides a hydrocarbon enriched stream (e.g., for recycle to the source gas, utilization for energy recovery, treatment with an oxidizer, vented, etc.), and an effluent stream that may be recycled (e.g., to the CO₂ plant), vented, or the like. An example permeate from the 2^{nd} stage membrane is +/−50% CO₂ (and roughly 45% CH₄). An example CO₂ PSA/TSA/VPSA adsorption component generates a relatively pure CO₂ (e.g., 97% purity or higher) stream and a tail gas stream that is enriched in CH₄ (e.g., +/−60 to 70%), which may be recycled to the source gas. Due to the fact that significant volumes of CO₂ have already been removed from the permeate stream via the PSA/TSA/VPSA technology, the volume to be re-processed by the RNG upgrading system is up to 50% lower, thereby freeing up throughput capacity in the compression and membrane configuration, saving in the required capital costs of the RNG upgrading system, and also saving on operating costs of the RNG upgrading system (e.g., compression costs are reduced by +/−15%).

A further example includes the permeate from the 1st stage membrane, which is usually vented to atmosphere, optionally combined with the product stream from the PSA/TSA/VPSA system and sent to the CO₂ plant assembly for recovery of the CO₂ and CH₄ slip. Although this will somewhat dilute the purity of the combined product stream going to the CO₂ plant, it will enable the capture of virtually all of the CO₂ from biogas stream, as well as all of the CH₄ stream.

Another example RNG upgrading process for a landfill gas is schematically depicted. An example system for the RNG upgrading process includes conditioning of a source gas, including dehydration, H₂S removal, compression, and/or VOC removal using a TSA/PSA component. The example system includes providing a permeate of the first membrane to a CO₂ PSA/TSA/VPSA adsorption component, which provides a CO₂ stream to a CO₂ plant assembly, and which utilizes the tail gas for a recycle to the source gas, provides the tail gas to an energy recovery assembly, and/or vents the tail gas. The example system includes recycling a second membrane permeate to the source gas, and/or recycling non-condensable gas from the CO₂ plant to the source gas. In the example system, an alternative gas (e.g., compressed air and/or nitrogen) may be utilized as a flush gas for the TSA/PSA component. In an alternate arrangement, the permeate from the first membrane may be utilized as a flush gas for the TSA/PSA component, and/or be passed as a feed gas to a CO₂ PSA/TSA/VPSA adsorption component, whether alternatively (e.g., the permeate provided as the flush gas, or as the feed gas for the CO₂ PSA/TSA/VPSA adsorption component), additionally (provided to both, with flush gas as needed), and/or in serial (e.g., all or a portion of the permeate is utilized to flush the TSA/PSA component, which is then passed on to the CO₂ PSA/TSA/VPSA adsorption component). An example system includes a standalone membrane that treats the non-condensable stream from the CO₂ plant, recycling and/or otherwise utilizing a hydrocarbon enriched portion, and venting or recycling to the CO₂ plant assembly and/or to the CO₂ PSA/TSA/VPSA adsorption component a remainder portion (e.g., CO₂ enriched). In a further example, a permeate from the second membrane may be utilized as a recycle to the source gas, and/or provided as a feed gas for the CO₂ PSA/TSA/VPSA adsorption component. In a further example, a retentate from the second membrane may be utilized as a hydrocarbon product stream.

An example RNG producer system from LFG is disclosed. In the example, the permeate stream from Stage 1 is provided to a CO₂ recovery plant, and utilized as needed as an inert purge gas for recovery operations of the adsorbers of the adsorption stage. The CO₂ recovery plant produces a high purity liquid CO₂ stream as a product, and purges non-condensable gases from the CO₂ recovery plant to be utilized as a part of the inert purge gas for recovery operations of the adsorbers of the adsorption stage. The permeate stream from Stage 2 is recycled to the intake of the LFG compressor.

Compositions of various streams of the example system are disclosed. The non-condensable gas stream from the CO₂ recovery plant includes the bulk of the non-CO₂ constituents of the permeate stream from Stage 1. The CO₂ product stream from the CO₂ recovery plant is a nearly pure CO₂ product stream, and it can be seen that the bulk of the overall CO₂ in the system is recovered in the CO₂ product stream.

Another example RNG producer system from LFG is disclosed. A secondary CH₄ recovery component is included to treat the purge stream of the CO₂ recovery plant arranged in a similar manner to the immediately preceding example. The purge stream of the CO₂ recovery plant includes a significant amount of CH₄, for example 20% CH₄, and can be separated by an appropriate separation device, such as a standalone membrane. The purge stream of the CO₂ recovery plant further includes significant remaining pressure—for example about 250 psig, allowing for the direct return of CH₄ recovered by the standalone membrane to a position downstream of the LFG compressor, improving overall CH₄ recovery, and saving re-compression energy for that portion of the recycled streams.

The permeate from Stage 2 is returned to a position upstream of the LFG compressor, and the CO₂ recovery plant provides a CO₂ recovery stream as in the immediately preceding example. In the immediately preceding example, the retentate of the standalone membrane provides the CH₄ recovery stream that is recycled to the position downstream of the LFG compressor, and the permeate of the standalone membrane is utilized, at least in part with the permeate from Stage 1, to provide the inert purge gas for recovery operations of the adsorbers of the adsorption stage. In this example, the CH₄ recovery stream is returned directly downstream of the LFG compressor (Stream is returned downstream of the LFG compressor and upstream of the adsorber stage), but the CH₄ recovery stream may be returned to any one of various places within the RNG processing stream, and/or the return location may be adjusted based on operating conditions or the like. Examples include returning the CH₄ recovery stream between the adsorber stage and Stage 1 (e.g., directly upstream of Stage 1), or between the Stages (e.g., downstream of Stage 1, and upstream of Stage 2).

It can be seen that a significant fraction of the CH₄ from the permeate of Stage 1 is recovered, the bulk of the overall CO₂ in the system is recovered in the CO₂ product stream, and compression losses for recovering the CH₄ from the permeate of Stage 1 are reduced by retaining and utilizing the high pressure from the retentate of the standalone membrane.

The immediately preceding example system provides for recovery of a majority of the CO₂ in the system, and provides a non-condensable stream that is clean, dry, and high pressure, suitable as a regeneration gas for the TSA/PSA system.

This example system provides for recovery of a majority of the CO₂ in the system, and enhanced recovery of CH₄ in the system provided in the product RNG stream. The high pressure of the non-condensable stream provides for high recovery of remaining CH₄, and allows for recycling of the stream at a position upstream of the LFG compressor, reducing energy utilization of the system. Further, the low pressure permeate stream from both a first stage membrane and the standalone membrane are clean and dry, providing a suitable regeneration gas for the TSA/PSA system.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

Example and illustrative embodiments are set forth herein to provide a clear description of aspects of the present disclosure. Methods described herein may be embodied, in whole or part, in systems that perform the steps thereof, and may be distributed across devices in a number of ways, or all of the functionality may be integrated into a dedicated, standalone device, or other hardware. Components of systems set forth herein may be arranged in a number of ways to achieve goals as set forth herein, and/or to achieve other goals that are evident from the disclosure herein. All such permutations and combinations are intended to fall within the scope of the present disclosure.

1. A gas recovery system, comprising:
a source gas conditioning assembly fluidly coupled to an inlet source gas, the source gas conditioning assembly comprising a compression component and a swing adsorption component, and configured to provide a conditioned source gas;
a first membrane assembly fluidly coupled to the conditioned source gas, and configured to separate the conditioned source gas into a hydrocarbon enriched stream and a recovery stream;
a second membrane assembly fluidly coupled to the hydrocarbon enriched stream, and configured to separate the hydrocarbon enriched stream into a hydrocarbon product stream and a recycle stream;
a carbon dioxide (CO₂) swing adsorption component fluidly coupled to the recovery stream, and configured to provide a CO₂ enriched stream and a flush gas stream;
a CO₂ plant assembly fluidly coupled to the CO₂ enriched stream, and configured to provide a carbon dioxide product stream and an enriched recycle stream;
a standalone membrane assembly fluidly coupled to the enriched recycle stream, and configured to separate the enriched recycle stream into a hydrocarbon enriched recycle stream and an effluent stream;
wherein the swing adsorption component is at least selectively coupled to the flush gas stream; and
wherein the source gas conditioning assembly is fluidly coupled to the recycle stream and the hydrocarbon enriched recycle stream.

2. The system of claim 1, wherein the hydrocarbon enriched recycle stream comprises a retentate of a standalone membrane of the standalone membrane assembly.

3. The system of claim 2, wherein the source gas conditioning assembly comprises a first fluid coupling to the hydrocarbon enriched recycle stream and a second fluid coupling to the recycle stream, and wherein the first fluid coupling is downstream of the second fluid coupling.

4.-5. (canceled)

6. The system of claim 1, wherein the recycle stream comprises a permeate of a second membrane of the second membrane assembly.

7. The system of claim 1, wherein the recovery stream comprises a permeate of a first membrane of the first membrane assembly.

8.-9. (canceled)

10. The system of claim 1, wherein the CO₂ plant assembly comprises:
a carbon adsorption bed;
a gas compression component;
a gas dehydration component; and
a liquefaction component.

11.-12. (canceled)

13. A gas recovery system, comprising:
a source gas conditioning assembly fluidly coupled to an inlet source gas, the source gas conditioning assembly comprising a compression component and a swing adsorption component, and configured to provide a conditioned source gas;
a first membrane assembly fluidly coupled to the conditioned source gas, and configured to separate the conditioned source gas into a hydrocarbon enriched stream and a recycle stream;
a second membrane assembly fluidly coupled to the hydrocarbon enriched stream, and configured to separate the hydrocarbon enriched stream into a hydrocarbon product stream and a recovery stream;
a carbon dioxide (CO₂) swing adsorption component fluidly coupled to the recovery stream, and configured to provide a CO₂ enriched stream and a flush gas stream;
a CO₂ plant assembly fluidly coupled to the CO₂ enriched stream, and configured to provide a carbon dioxide product stream and an enriched recycle stream;
a standalone membrane assembly fluidly coupled to the enriched recycle stream, and configured to separate the enriched recycle stream into a hydrocarbon enriched recycle stream and an effluent stream;
wherein the swing adsorption component is at least selectively coupled to at least one of the flush gas stream or an alternate flush gas source; and
wherein the source gas conditioning assembly is fluidly coupled to the recycle stream and the hydrocarbon enriched recycle stream.

14. The system of claim 13, wherein the hydrocarbon enriched recycle stream comprises a retentate of a standalone membrane of the standalone membrane assembly.

15. The system of claim 14, wherein the source gas conditioning assembly comprises a first fluid coupling to the hydrocarbon enriched recycle stream and a second fluid coupling to the recycle stream, and wherein the first fluid coupling is downstream of the second fluid coupling.

16. The system of claim 15, wherein the first fluid coupling comprises a higher average pressure position than the second fluid coupling.

17. The system of claim 15, wherein the first fluid coupling is downstream of a compressor component of the source gas conditioning assembly.

18.-19. (canceled)

20. The system of claim 13, wherein the enriched recycle stream comprises non-condensable gases from the CO₂ plant assembly.

21. The system of claim 20, wherein the enriched recycle stream passes directly from the CO₂ plant assembly to the standalone membrane assembly without being pressurized.

22. (canceled)

23. A gas recovery system, comprising:
a source gas conditioning assembly fluidly coupled to an inlet source gas, the source gas conditioning assembly comprising a compression component and a swing adsorption component, and configured to provide a conditioned source gas;
a first membrane assembly fluidly coupled to the conditioned source gas, and configured to separate the conditioned source gas into a hydrocarbon enriched stream and a recovery stream;
a second membrane assembly fluidly coupled to the hydrocarbon enriched stream, and configured to separate the hydrocarbon enriched stream into a hydrocarbon product stream and a recycle stream;
a carbon dioxide (CO₂) swing adsorption component fluidly coupled to the recovery stream, and configured to provide a CO₂ enriched stream and a flush gas stream;
a CO₂ plant assembly fluidly coupled to the CO₂ enriched stream, and configured to provide a carbon dioxide product stream and an enriched recycle stream;
a standalone membrane assembly fluidly coupled to the enriched recycle stream, and configured to separate the enriched recycle stream into a hydrocarbon enriched recycle stream and a secondary recovery stream;
wherein the CO₂ plant assembly is fluidly coupled to the secondary recovery stream;
wherein the swing adsorption component is at least selectively coupled to the flush gas stream; and
wherein the source gas conditioning assembly is fluidly coupled to the recycle stream and the hydrocarbon enriched recycle stream.

24. The system of claim 23, wherein the hydrocarbon enriched recycle stream comprises a retentate of a standalone membrane of the standalone membrane assembly.

25. The system of claim 24, wherein the source gas conditioning assembly comprises a first fluid coupling to the hydrocarbon enriched recycle stream and a second fluid coupling to the recycle stream, and wherein the first fluid coupling is downstream of the second fluid coupling.

26. The system of claim 25, wherein the first fluid coupling comprises a higher average pressure position than the second fluid coupling.

27. The system of claim 25, wherein the first fluid coupling is downstream of a compressor component of the source gas conditioning assembly.

28.-68. (canceled)

69. The system of claim 13, wherein the alternate flush gas source comprises at least one of an air source or a nitrogen source.

70. The system of claim 13, wherein the alternate flush gas source comprises an inert gas source.
